(19) United States
(12) Patent Application Publication
(10) Pub. No.: US 2019/0340460 A1
(43) Pub. Date: Nov. 7, 2019

(54) TEXT LINE DETECTING METHOD AND TEXT LINE DETECTING DEVICE

(71) Applicant: ZhongAn Information Technology Service Co., Ltd., Shenzhen (CN)

(72) Inventors: Hongyu LI, Shenzhen (CN); Yuxiang PENG, Shenzhen (CN)

(21) Appl. No.: 16/513,883

(22) Filed: Jul. 17, 2019

Related U.S. Application Data
(63) Continuation of application No. PCT/CN2018/110004, filed on Oct. 12, 2018.

(30) Foreign Application Priority Data
Oct. 13, 2017 (CN) 201710953107.1

(51) Int. Cl. G06K 9/44; G06K 9/46

(52) U.S. Cl. CPC G06K 9/44; G06K 2209/01; G06K 9/4609; G06K 9/4642

(57) ABSTRACT

A text line detecting method includes: performing a preprocessing operation on an image to be detected to generate connected domains; performing a filtering operation on the connected domains to obtain connected domains that meet a preset requirement; and perform a text line recognizing operation according to a processing result. In the text line detecting method according to the embodiments of the present invention, by means of performing the preprocessing operation and the filtering operation on the image to be detected to obtain the connected domains that meet the preset requirement, and then performing the text line recognizing operation according to the processing result,detection and recognition accuracy of a text line are improved, and detection and recognition efficiencies of the text line are improved.

### CROSS-REFERENCE TO RELATED APPLICATIONS

This application is a continuation of International Application No. PCT/CN2018/110004 filed on Oct. 12, 2018, which claims priority to Chinese patent application No. 201710953107.1 filed on Oct. 13, 2017. Both applications are incorporated herein by reference in their entireties.

### TECHNICAL FIELD

Embodiments of the present invention relate to the field of computer image processing, and particularly to a text line detecting method and a text line detecting device.

### BACKGROUND

Text line detection in images is a research hot spot of text image processing, and it is also one of the most important links of Optical Character Recognition (OCR). Since a text part in an image often contains important information of the image,the detection of text lines in the image plays an important role in image analysis and image information acquisition.

Existing text line detecting methods mainly include traditional methods and deep learning methods. The deep learning methods are applicable to a wide range of scenes, and recognition accuracy of the deep learning methods is relatively high. However, a large amount of high-quality labeled data and a long-term training adjustment process are required in the deep learning methods, and the amount of calculation is huge in each detecting operation, so that the deep learning methods are time-consuming and are not conducive to rapid identification processing. The traditional methods have low accuracy and more false positives which need to be removed by post processing. Therefore, a fast and accurate text line detecting method is urgently needed.

### SUMMARY

In view of this, embodiments of the present invention provide a text line detecting method and a text line detecting device, in order to solve a problem of poor detection precision and low detection efficiency of an existing text line detecting method.

In a first aspect, an embodiment of the present invention provides a text line detecting method. The text line detecting method includes:performing a preprocessing operation on an image to be detected to generate connected domains;performing a filtering operation on the connected domains to obtain connected domains that meet a preset requirement; and performing a text line recognizing operation according to a processing result.

Optionally, the performing a preprocessing operation on an image to be detected to generate connected domains includes: performing a binarization processing operation on the image to be detected; and generating the connected domains according to the processed image to be detected.

Optionally, after the performing a binarization processing operation on the image to be detected, the method further includes: performing a closing operation on the image to be detected after the binarization processing operation.

Optionally, the performing a filtering operation on the connected domains to obtain connected domains that meet a preset requirement includes: performing a fine filtering operation on the connected domains according to preset standard size data and size data of the obtained connected domains to acquire the connected domains that meet the preset requirement.

Optionally, before the performing a fine filtering operation on the connected domains according to preset standard size data and size data of the obtained connected domains to acquire the connected domains that meet the preset requirement, the method further includes: performing a coarse filtering operation on the connected domains according to a preset abnormal threshold and the size data of the obtained connected domains; performing a clustering statistical operation on the size data of the connected domains after the coarse filtering operation; and regarding size data which the number of occurrence times reaching the number of preset times as the preset standard size data.

Optionally, the preset abnormal threshold includes either or both of a preset abnormal threshold set according to a pixel and a preset abnormal threshold set according to the size data of the connected domains.

Optionally, after the performing a filtering operation on the connected domains to obtain connected domains that meet a preset requirement, the method further includes: generating outer bounding boxes corresponding to the obtained connected domains that meet the preset requirement.

Optionally, after the generating outer bounding boxes corresponding to the obtained connected domains that meet the preset requirement, the method further includes: generating extended bounding boxes based on the outer bounding boxes according to a preset ratio; and performing an aggregating processing operation on the outer bounding boxes according to the generated extended bounding boxes.

Optionally, the generating extended bounding boxes based on the outer bounding boxes according to a preset ratio includes: extending each of the outer bounding boxes of the connected domains into an extended bounding box which a width is greater than a height according to the preset ratio, and a center of each of the outer bounding boxes is aligned with a center of the corresponding extended bounding box.

Optionally, the performing an aggregating processing operation on the outer bounding boxes according to the generated extended bounding boxes includes: judging whether an IOU value of extended bounding boxes corresponding to at least two connected domains reaches a preset IOU threshold range; and when the IOU value of the extended bounding boxes corresponding to the at least two connected domains reaches the preset IOU threshold range, performing the aggregating processing operation on the outer bounding boxes corresponding to the extended bounding boxes of the at least two connected domains to generate an aggregation class including at least two outer bounding boxes.

Optionally, the performing a text line recognizing operation according to a processing result includes:when the number of the outer bounding boxes in the aggregation class is greater than or equal to a preset number, and a variance of central position coordinates of the outer bounding boxes in the aggregation class is less than a preset value, determining the connected domains in the aggregation class as a text line.

In a second aspect, an embodiment of the present invention further provides a text line detecting device. The text line detecting device includes a memory, a processor, and a computer program stored in the memory and executed by the processor, when the computer program is executed by the processor, the processor implements the following steps:performing a preprocessing operation on an image to be detected to generate connected domains; performing a filter operation on the connected domains to obtain connected domains that meet a preset requirement; and performing a text line recognizing operation according to a processing result.

Optionally,when implementing the step of performing a preprocessing operation on an image to be detected to generate connected domains, the processor specifically implements the following steps: performing a binarization processing operation on the image to be detected; and generating the connected domains according to the processed image to be detected.

Optionally,when implementing the step of performing a preprocessing operation on an image to be detected to generate connected domains, the processor specifically further implements the following step: performing a closing operation on the image to be detected after the binarization processing operation.

Optionally,when implementing the step of performing a filter operation on the connected domains to obtain connected domains that meet a preset requirement, the processor specifically implements the following step: performing a fine filtering operation on the connected domains according to preset standard size data and size data of the obtained connected domains to acquire the connected domains that meet the preset requirement.

Optionally,when implementing the step of performing a filter operation on the connected domains to obtain connected domains that meet a preset requirement, the processor specifically further implements the following steps: performing a coarse filtering operation on the connected domains according to a preset abnormal threshold and the size data of the obtained connected domains; performing a clustering statistical operation on the size data of the connected domains after the coarse filtering operation; and regarding size data which the number of occurrence times reaching the number of preset times as the preset standard size data.

Optionally, the preset abnormal threshold includes either or both of a preset abnormal threshold set according to a pixel and a preset abnormal threshold set according to size data of a connected domain.

Optionally,when the computer program is executed by the processor, the processor further implements the following step: generating outer bounding boxes corresponding to the obtained connected domains that meet the preset requirement.

Optionally,when the computer program is executed by the processor, the processor further implements the following steps: generating extended bounding boxes based on the outer bounding boxes according to a preset ratio; and performing an aggregating operation on the outer bounding boxes according to the extended bounding boxes.

Optionally, when implementing the step of generating extended bounding boxes based on the outer bounding boxes according to a preset ratio, the processor specifically further implements the following steps: extending each of the outer bounding boxes of the connected domains into an extended bounding box which a width is greater than a height according to the preset ratio, and making a center of each of the outer bounding boxes being aligned with a center of the corresponding extended bounding box.

Optionally, when implementing the step of performing an aggregating operation on the outer bounding boxes according to the generated extended bounding boxes, the processor specifically implements the following steps: judging whether an IOU value of extended bounding boxes corresponding to at least two connected domains reaches a preset IOU threshold range; and performing the aggregating processing operation on the outer bounding boxes corresponding to the extended bounding boxes of the at least two connected domains,when the IOU value of the extended bounding boxes corresponding to the at least two connected domains reaches the preset IOU threshold range, to generate an aggregation class including at least two outer bounding boxes.

Optionally,when implementing the step of performing a text line recognizing operation according to a processing result, the processor specifically implements the following step: determining the connected domains in the aggregation class as a text line, when the number of the outer bounding boxes in the aggregation class is greater than or equal to a preset number, and a variance of central position coordinates of the outer bounding boxes in the aggregation class is less than a preset value.

In a third aspect, an embodiment of the present invention further provides a computer readable storage medium storing a data sharing program for causing a processor to execute the text line detecting method according to any one of the above embodiments.

Beneficial effects of technical solutions according to the embodiments of the present invention include the following contents.

The embodiments of the present invention provide a text line detecting method and a text line detecting device. In the text line detecting method according to the embodiments of the present invention, by means of performing the binarization preprocessing operation on the input image, and performing the filtering operation on the connected domains of the binarization image, the abnormal connected domain and the non-text image area may be removed by the filtering operation. Thereby, interferences of the abnormal connected domain and the non-text image area for detecting the text line may be avoided, and accuracy and efficiency of detection of the text line are improved. Further, in the text line detecting method according to the embodiments of the present invention,the outer bounding boxes are generated according to the size data of the connected domains, and the outer bounding boxes of the connected domains conforming to the standard font size are extended according to a preset ratio to generate the extended bounding boxes. Since the center of each of the generated extended bounding boxes being aligned with the center of the corresponding outer bounding box, the aggregating processing operation may be performed on the outer bounding boxes according to the extended bounding boxes. Thereby, the text line may be recognized according to the result of the aggregating processing operation. Coordinates of aggregation centers may be obtained after performing the aggregating processing operation on the outer bounding boxes, and if a preset number of the outer bounding boxes are connected, the text line may be recognized. Therefore, in the text line detecting method according to the embodiments of the present invention, the speed of detecting the text line in the image is improved while detection precision and accuracy may be ensured, and the detection efficiency may be improved.

### BRIEF DESCRIPTION OF DRAWINGS

In order to illustrate technical solutions in embodiments of the present invention clearer, brief introductions of accompanying drawings used in descriptions of the embodiments will be given below. Apparently, the accompanying drawings in the following descriptions are merely some embodiments of the present invention. For those skilled in the art, other accompanying drawings may further be obtained according to the accompanying drawings without any inventive effort.

FIG. 1 is a schematic flowchart of a text line detecting method according to an embodiment of the present invention.

FIG. 2 is a schematic flowchart of performing a preprocessing operation on an image to be detected to generate connected domains of a text line detecting method according to an embodiment of the present invention.

FIG. 3 is a schematic flowchart of performing a preprocessing operation on an image to be detected to generate connected domains of a text line detecting method according to another embodiment of the present invention.

FIG. 4 is a schematic flowchart of performing a filtering operation on the connected domains to obtain connected domains that meet a preset requirement of a text line detecting method according to an embodiment of the present invention.

FIG. 5 is a schematic flowchart of a text line detecting method according to another embodiment of the present invention.

FIG. 6 is a schematic flowchart of a text line detecting method according to still another embodiment of the present invention.

FIG. 7 is a schematic flowchart of performing an aggregating operation on outer bounding boxes according to generated extended bounding boxes of a text line detecting method according to an embodiment of the present invention.

FIG. 8 is a schematic flowchart of a text line detecting method according to yet still another embodiment of the present invention.

FIG. 9a is a sample input image for a text line detection according to an embodiment of the present invention.

FIG. 9b is a schematic image after preprocessing the sample input image according to the embodiment of the present invention.

FIG. 9c is a schematic image of a final text detection result of the sample input image according to the embodiment of the present invention.

FIG. 10 is a schematic structural diagram of a text line detecting device according to an embodiment of the present invention.

FIG. 11 is a schematic structural diagram of a connected domain generating module of a text line detecting device according to an embodiment of the present invention.

FIG. 12 is a schematic structural diagram of a connected domain generating module of a text line detecting device according to another embodiment of the present invention.

FIG. 13 is a schematic structural diagram of a filtering module of a text line detecting device according to an embodiment of the present invention.

FIG. 14 is a schematic structural diagram of a text line detecting device according to another embodiment of the present invention.

FIG. 15 is a schematic structural diagram of a text line detecting device according to still another embodiment of the present invention.

FIG. 16 is a schematic structural diagram of an aggregating module of a text line detecting device according to an embodiment of the present invention.

FIG. 17 is a schematic structural diagram of a text line detecting device according to yet still another embodiment of the present invention.

FIG. 18 is a schematic structural diagram of an electronic equipment according to an embodiment of the present invention.

### DETAILED DESCRIPTION

In order to make objects, technical solutions, and advantages of the present invention clearer, the technical solutions in embodiments of the present invention will be clearly and completely described below in combination with accompanying drawings in the embodiments of the present invention. Apparently, the embodiments described below are only a part, but not all of the embodiments of the present invention. All other embodiments, obtained by those skilled in the art based on the embodiments of the present invention without any inventive effort, fall into the protection scope of the present invention.

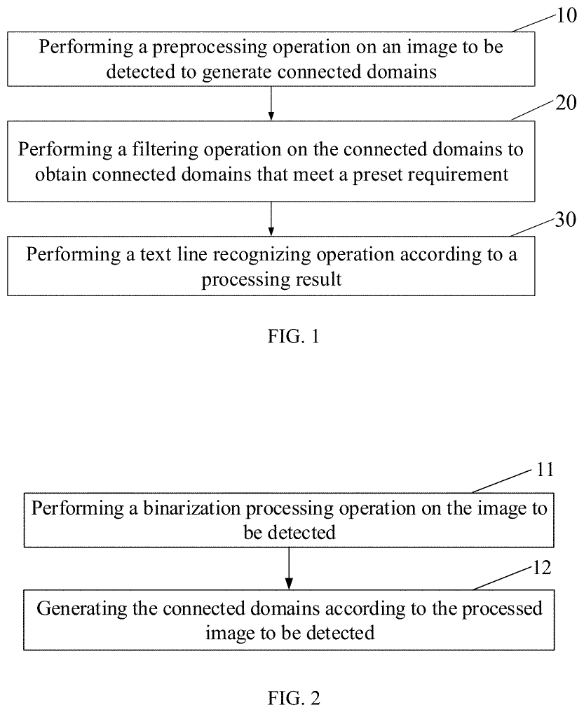

FIG. 1 is a schematic flowchart of a text line detecting method according to an embodiment of the present invention. As shown in FIG. 1, the text line detecting method according to the embodiment of the present invention includes the following steps.

10: performing a preprocessing operation on an image to be detected to generate connected domains.

It may be noted that the preprocessing operation mentioned in the step 10 refers to a processing operation that can generate the connected domains according to the image to be detected. The processing operation includes, but is not limited to, a binarization processing operation and so on.

For example, FIG. 2 is a schematic flowchart of performing a preprocessing operation on an image to be detected to generate connected domains of a text line detecting method according to an embodiment of the present invention. As shown in FIG. 2, in the text line detecting method according to the embodiment of the present invention, the performing a preprocessing operation on an image to be detected to generate connected domains includes the following steps.

11: performing a binarization processing operation on the image to be detected.

12: generating the connected domains according to the processed image to be detected.

That is to say, in an actual application process, an implementation process of the performing a preprocessing operation on an image to be detected to generate connected domains includes: performing the binarization processing operation on the image to be detected, and then generating the connected domains according to the processed image to be detected.

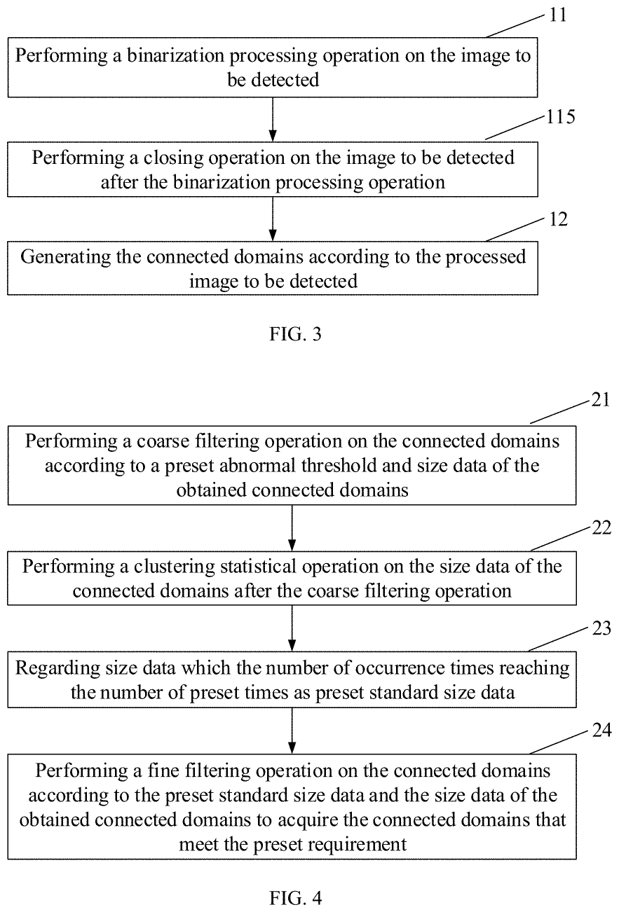

In another embodiment of the present invention, the step of performing a preprocessing operation on an image to be detected to generate connected domains further includes a closing operation process. For example, an embodiment shown in FIG. 3 of the present invention is extended on the basis of the embodiment shown in FIG. 2. FIG. 3 is a schematic flowchart of performing a preprocessing operation on an image to be detected to generate connected domains of a text line detecting method according to another embodiment of the present invention. As shown in FIG. 3, in the text line detecting method according to the embodiment of the present invention, after the performing a binarization processing operation on the image to be detected, the method further includes the following step.

115: performing a closing operation on the image to be detected after the binarization processing operation.

That is to say, in an actual application process, an implementation process of the performing a preprocessing operation on an image to be detected to generate connected domains includes: performing the binarization processing operation on the image to be detected, and then performing the closing operation on the image to be detected after the binarization processing operation, and generating the connected domains according to the processed image to be detected.

It may be understood that since aword after the preprocessing operation may be disconnected, a morphological closing operation method may be used to reconnect the disconnected word to ensure that a same word is connected into a same connected domain. Thereby, detection accuracy of a character may be further improved.

20: performing a filtering operation on the connected domains to obtain connected domains that meet a preset requirement.

It may be noted that the filtering operation is for filtering out one or more connected domains that do not meet the preset requirement, so as to retain and obtain the connected domains that meet the preset requirement. The connected domain that does not meet the preset requirement may be, but is not limited to,a connected domain that does not include a word, or a connected domain that is abnormal in size and so on.

It may be understood that the specific preset requirement may be set according to an actual situation, so as to fully improve adaptability and wide application of the text line detecting method according to the embodiments of the present invention. The specific preset requirement is not uniformly limited in the embodiments of the present invention.

30: performing a text line recognizing operation according to a processing result.

In an actual application process, firstly the image to be detected is preprocessed to generate the connected domains, and then the generated connected domains are filtered to obtain the connected domains that meet the preset requirement, and finally the text line recognizing operation is performed according to the obtained connected domains that meet the preset requirement (i.e.,the processing result).

In the text line detecting method according to the embodiments of the present invention, by means of performing the preprocessing operation and the filtering operation on the image to be detected to obtain the connected domains that meet the preset requirement, and then performing the text line recognizing operation according to the processing result, an element such as a word in the image to be detected may be presented in a form of connected domain, and an interference of an abnormal connected domain may be removed according to the filtering operation. Thereby, detection and recognition accuracy of a text line are improved, and detection and recognition efficiencies of the text line are improved.

FIG. 4 is a schematic flowchart of performing a filtering operation on the connected domains to obtain connected domains that meet a preset requirement of a text line detecting method according to an embodiment of the present invention. As shown in FIG. 4, in the embodiment of the present invention, the performing a filtering operation on the connected domains to obtain connected domains that meet a preset requirement includes the following steps.

21: performing a coarse filtering operation on the connected domains according to a preset abnormal threshold and size data of the obtained connected domains.

It may be noted that the coarse filtering operation mentioned in the step 21 refers to filtering out a connected domain whose size data falls into a range of the preset abnormal threshold according to the obtained preset abnormal threshold and the size data of the obtained connected domains,so as to remain a connected domain whose size data does not fall into the range of the preset abnormal threshold.

It may be understood that a specific value of the preset abnormal threshold may be set according to an actual situation, so as to fully improve adaptability and wide application of the text line detecting method according to the embodiments of the present invention. The specific value of the preset abnormal threshold is not uniformly limited in the embodiments of the present invention.

22: performing a clustering statistical operation on the size data of the connected domains after the coarse filtering operation.

23: regarding size data which the number of occurrence times reaching the number of preset times as preset standard size data.

In addition, it may be understood that a specific value of the number of preset times may be set according to an actual situation, so as to fully improve the adaptability and wide application of the text line detecting method according to the embodiments of the present invention. The specific value of the number of preset times is not uniformly limited in the embodiments of the present invention.

24: performing a fine filtering operation on the connected domains according to the preset standard size data and the size data of the obtained connected domains to acquire the connected domains that meet the preset requirement.

It may be noted that the fine filtering operation mentioned in the step 24 refers to performing a re-filtering operation on the connected domains after the coarse filtering operation according to the obtained preset standard size data and the size data of the connected domains after the coarse filtering operation. Therefore, one or more non-text connected domains of the connected domains may be removed effectively, and accuracy and efficiencies of detection and recognition may be further improved.

In addition, it may be noted that the coarse filtering operation and the fine filtering operation do not necessarily exist at the same time, and which filtering operation being included in the text line detecting method may be set flexibly according to an actual situation. For example, in a text line detecting method according to another embodiment of the present invention, the coarse filtering operation is not included.

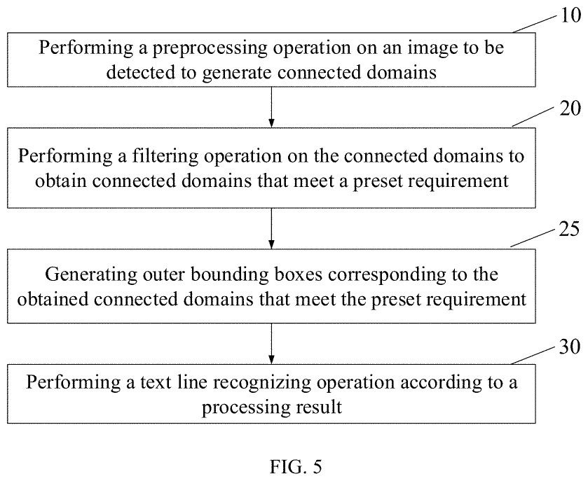

FIG. 5 is a schematic flowchart of a text line detecting method according to another embodiment of the present invention. The embodiment of the present invention is extended on the basis of the embodiment shown in FIG. 1 of the present invention. Differences between the embodiment of the present invention and the embodiment shown in FIG. 1 are mainly described below, and similarities are not described redundantly herein.

As shown in FIG. 5, in the text line detecting method according to the embodiment of the present invention, after the performing a filtering operation on the connected domains to obtain connected domains that meet a preset requirement, the method further includes the following step.

25: generating outer bounding boxes corresponding to the obtained connected domains that meet the preset requirement.

In an actual application process, firstly an image to be detected is preprocessed to generate connected domains, and then the generated connected domains are filtered to obtain the connected domains that meet the preset requirement, and the outer bounding boxes corresponding to the obtained connected domains that meet the preset requirement are generated, and finally a text line recognizing operation is performed.

It may be noted that, by using the generated outer bounding boxes, size data of the connected domains may be counted more conveniently and accurately. Therefore, more accurate identification bases may be provided for the subsequent text line recognizing operation, so that speeds and efficiencies of detecting and recognizing a text line are further improved.

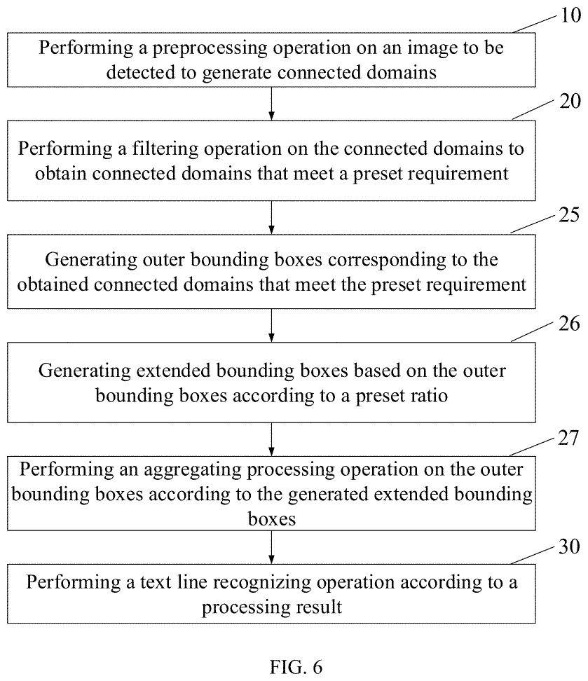

FIG. 6 is a schematic flowchart of a text line detecting method according to still another embodiment of the present invention. The embodiment of the present invention is extended on the basis of the embodiment shown in FIG. 5 of the present invention. Differences between the embodiment of the present invention and the embodiment shown in FIG. 5 are mainly described below, and similarities are not described redundantly herein.

As shown in FIG. 6, in the text line detecting method according to the embodiment of the present invention, after the generating outer bounding boxes corresponding to the obtained connected domains that meet the preset requirement, the method further includes the following steps.

26: generating extended bounding boxes based on the outer bounding boxes according to a preset ratio.

It may be noted that a specific value of the preset ratio may be set according to an actual situation, so as to fully improve adaptability and wide application of the text line detecting method according to the embodiment of the present invention. The specific value of the preset ratio is not uniformly limited in the embodiments of the present invention.

27:performing an aggregating processing operation on the outer bounding boxes according to the generated extended bounding boxes.

It may be understood that the aggregating processing operation mentioned in the step 27 refers to aggregating the outer bounding boxes of the connected domains according to intersection situations of the extended bounding boxes.

In an actual application process, firstly an image to be detected is preprocessed to generate the connected domains, and then the generated connected domains are filtered to obtain the connected domains that meet the preset requirement, and the outer bounding boxes corresponding to the connected domains that meet the preset requirement are generated, and the extended bounding boxes are generated based on the outer bounding boxes according to the preset ratio, and the aggregating processing operation is performed on the outer bounding boxes according to the generated extended bounding boxes, and finally a text line recognizing operation is performed according to a processing result.

In the text line detecting method according to the embodiments of the present invention, by means of the extended bounding boxes and the aggregating processing operation according to the extended bounding boxes, recognition accuracy of a text line is improved, and probability of erroneous recognition is reduced.

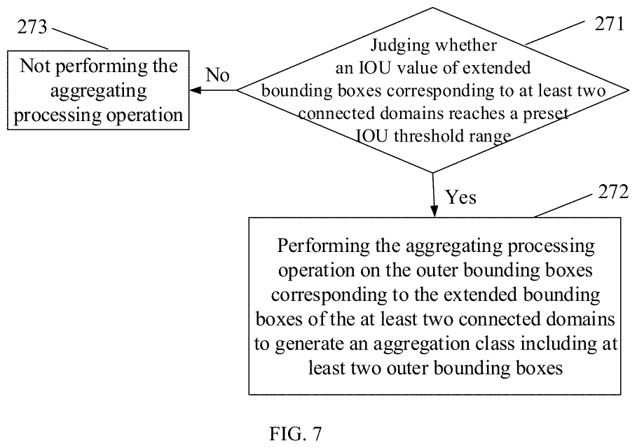

In an embodiment of the present invention, a specific implementation manner of the performing an aggregating processing operation on the outer bounding boxes according to the generated extended bounding boxes is shown in FIG. 7. Specifically, FIG. 7 is a schematic flowchart of performing an aggregating operation on outer bounding boxes according to generated extended bounding boxes of a text line detecting method according to an embodiment of the present invention. As shown in FIG. 7, the performing an aggregating processing operation on the outer bounding boxes according to the generated extended bounding boxes includes the following steps.

271: judging whether an IOU value of extended bounding boxes corresponding to at least two connected domains reaches a preset IOU threshold range.

The IOU value refers to a ratio of an intersection range to a union of the at least two connected domains.

272:when the IOU value of the extended bounding boxes corresponding to the at least two connected domains reaches the preset IOU threshold range, performing the aggregating processing operation on the outer bounding boxes corresponding to the extended bounding boxes of the at least two connected domains to generate an aggregation class including at least two outer bounding boxes.

273: not performing the aggregating processing operation.

An actual implementation process of the performing an aggregating processing operation on the outer bounding boxes according to the generated extended bounding boxes includes: judging whether the IOU value of the extended bounding boxes corresponding to the at least two connected domains reaches the preset IOU threshold range, and when a judgment result is yes, that is, when the IOU value of the extended bounding boxes corresponding to the at least two connected domains reaches the preset IOU threshold range, performing the aggregating processing operation on the outer bounding boxes corresponding to the extended bounding boxes of the at least two connected domains to generate the aggregation class including at least two outer bounding boxes; and when the judgment result is no, not performing the aggregating processing operation.

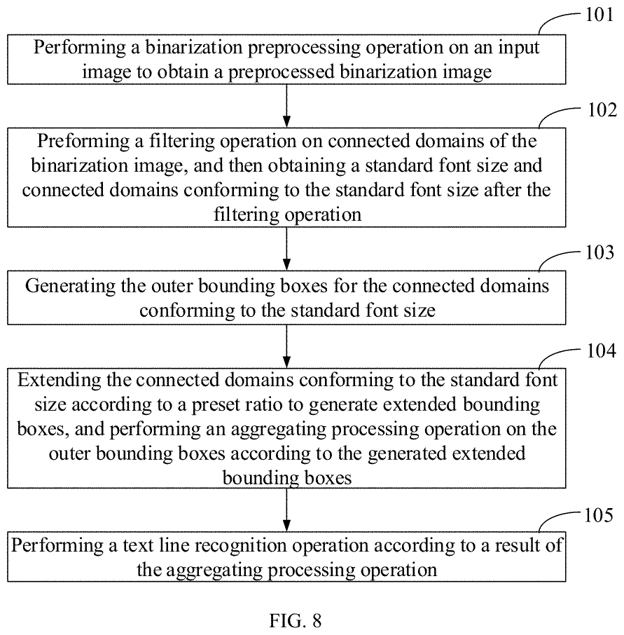

FIG. 8 is a schematic flowchart of a text line detecting method according to yet still another embodiment of the present invention. The text line detecting method is provided by the embodiment of the present invention. As shown in FIG. 8, the method includes the following steps.

101: performing a binarization preprocessing operation on an input image to obtain a preprocessed binarization image.

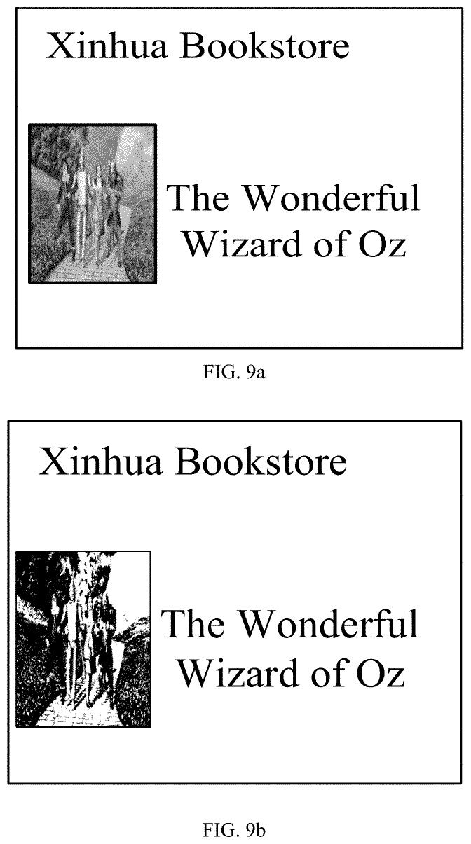

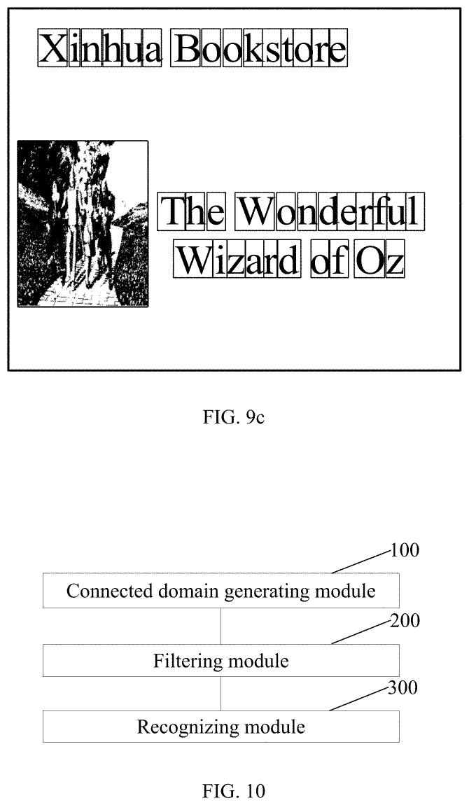

The input image may include different types of objects, such as a word, an illustration, a logo, a bar code, a Quick Response code, various symbols and so on. Text forms in the input image may include different fonts, different font sizes, different languages (such as Chinese, English, etc.), numbers, Latin letters and so on. In order to illustrate the text line detecting method mentioned in the embodiment of the present invention, a sample image will be illustrated, and the input image may be an image shown in FIG. 9a.

It may be understood that the input image mentioned in the embodiments of the present invention refers to the image to be detected mentioned in the above embodiments.

For example, a Sauvola binarization algorithm is adopted to perform the binarization preprocessing operation on the input image. The Sauvola binarization algorithm has a good processing effect on an image with uneven illumination distribution, a poor binarization preprocessing effect caused by uneven illumination distribution of the image may be effectively avoided, and then a text line recognizing operation may not be affected. Thereby, effect and accuracy of the text line recognizing operation may be further improved by adopting the Sauvola binarization algorithm.

A process of the performing the binarization preprocessing operation on the input image by adopting the Sauvola binarization algorithm may include the following steps.

a. presetting a processing window parameter of the input image to be processed when the Sauvola binarization algorithm is adopted to perform the binarization preprocessing operation on the input image.

For example, two processing window parameters including a window size (m*n) and a parameter k of the input image need to be set. Both the window size (m*n) and the parameter k may be empirical values, a value range of the window size (m*n) is [9, 13], and a value range of the k is [0.05, 0.11].

The adopted Sauvola binarization algorithm may use a local mean value as a threshold value. If a standard deviation of a local image is large, the threshold value is large; and if the standard deviation of the local image is small, the threshold value is relatively small.

b. performing a closing operation on the input image after the Sauvola binarization preprocessing operation.

Specifically, since a word after the preprocessing operation may be disconnected, at this time, a morphological closing operation method may be used to reconnect the disconnected word. A square structure element with a side length L may be used in the closing operation, and the L is an empirical value, a value range of the L is [3, 7].

By performing the closing operation after the Sauvola binarization preprocessing operation, a word may be ensured to be connected to a same connected domain as much as possible. Thereby, detection accuracy of a character may be improved, and a subsequent recognition operation for a text line in the image according to the connected domain may be facilitated.

102: preforming a filtering operation on connected domains of the binarization image, and then obtaining a standard font size and connected domains conforming to the standard font size after the filtering operation.

The binarization image refers to the input image after the binarization preprocessing operation.

In the embodiments of the present invention, the adopted filtering operation may include a coarse filtering operation and a fine filtering operation. In an actual application, the filtering operation may also be performed in other manners,which is not limited in the embodiments of the present invention.

A process of performing the coarse filtering operation on the connected domains of the binarization image may include the following steps.

a. obtaining the connected domains of the binarization image, and filtering one or more abnormal connected domains of the connected domains according to a preset abnormal threshold.

The abnormal threshold may refer to an abnormal threshold set according to a pixel or an abnormal threshold set according to a width-to-height ratio of a connected domain. For example, the abnormal threshold set according to a pixel may refer to that the number of the pixels is less than 10 or more than 100000. The abnormal threshold set according to a width-to-height ratio of a connected domain may refer to that the width-to-height ratios or height-to-width ratios are greater than 15. A specific setting value of the abnormal threshold may be an empirical value.

For example, if the abnormal threshold includes the abnormal threshold set according to a pixel, the filtering one or more abnormal connected domains of the connected domains according to the preset abnormal threshold includes:

obtaining the connected domains of the binarization image, and removing a connected domain which the number of pixels less than 10, or removing a connected domain which the number of pixels more than 100000, or removing the connected domain which the number of pixels less than 10 and the connected domain which the number of pixels more than 100000.

If the abnormal threshold includes the abnormal threshold set according to a width-to-height ratio of a connected domain, the filtering one or more abnormal connected domains of the connected domains according to the preset abnormal threshold includes:

obtaining the connected domains of the binarization image, and obtaining a width value and a height value of each of the connected domains, and removing a connected domain with a width-to-height ratio or a height-to-width ratio greater than 15.

b. obtaining width values and height values of the remaining connected domains after the coarse filtering operation, clustering the width values and the height values of the remaining connected domains after the coarse filtering operation by using a statistical clustering algorithm, to count a width value and a height value of a connected domain with the most number of occurrence times as a standard font size.

For example, corresponding outer bounding boxes are generated for the remaining connected domains after the coarse filtering operation, and the width value and the height value of the outer bounding box corresponding to each remaining connected domain are counted, and the width value and the height value of the outer bounding box are regarded as the width value and the height value of each corresponding connected domain.

The width value and the height value of each remaining connected domain are clustered by using the statistical clustering algorithm, and occurrence frequencies of each width value and each height value are counted, a width value and a height value of a connected domain with the most number of occurrence times are obtained to act as a standard width value and a standard height value. The standard width value and the standard height value may refer to a width size and a height size of a standard font.

A process of performing the fine filtering operation on the connected domains of the binarization image may include the following steps.

a. according to the standard font size, filtering the remaining connected domains after the coarse filtering operation in the binarization image according to a preset multiple of the width value and the height value of the standard font size.

The preset multiple may be 3, which means a width is 3 times the width of the standard font size, and a height is 3 times the height of the standard font size. It may be noted that the preset multiple may be set according to an actual requirement of the fine filtering operation, so that the preset multiple is an empirical value. The preset multiple is not limited in the embodiments of the present invention.

For example, for the remaining connected domains after the coarse filtering operation, a connected domain whose width being 3 times greater than the width of the standard font size may be filtered again, or a connected domain whose height being 3 times greater than the height of the standard font size may be filtered again, or a connected domain whose width being 3 times greater than the width of the standard font size and whose height being 3 times greater than the height of the standard font size may be filtered again.

By means of performing the fine filtering operation on the remaining connected domains after the coarse filtering operation, a non-text image area in the image may be removed. Thereby,an interference of the non-text image area in the image for a text line recognition may be eliminated, and the subsequent recognition of the text line may be further facilitated and efficiency and accuracy of recognition may be improved.

b. obtaining the connected domains after the fine filtering operation in the binarization image.

For example, the binarization image after the preprocessing operation is filtered coarsely and finely to obtain the remaining connected domains after the filtering operations.

103: generating the outer bounding boxes for the connected domains conforming to the standard font size.

For example, the process includes:

for the corresponding outer bounding boxes generated by the remaining connected domains after the coarse filtering operation in the step b of the 102, removing the outer bounding boxes corresponding to the connected domains filtered out by the fine filtering operation; or

after the coarse filtering operation and the fine filtering operation, obtaining the remaining connected domains conforming to the standard font size, and generating the outer bounding boxes corresponding to the remaining connected domains.

By means of generating the outer bounding boxes for the connected domains conforming to the standard font size, the width and the height values of the connected domains may be conveniently counted. Thereby speed and efficiency of recognition may be further improved.

104: extending the connected domains conforming to the standard font size according to a preset ratio to generate extended bounding boxes, and performing an aggregating processing operation on the outer bounding boxes according to the generated extended bounding boxes.

a. the process of extending the connected domains conforming to the standard font size according to a preset ratio to generate extended bounding boxes may include:

converting each of the connected domains conforming to the standard font size to a corresponding extended bounding box which a width is greater than a height according to the preset ratio,and making a center of the extended bounding box being aligned with a center of the corresponding outer bounding box.

For example, each of the extended bounding boxes may be generated by extending the outer bounding box of the corresponding connected domain according to the preset ratio. The preset ratio may refer to that the width of the extended bounding box is 2.8 times the width of the outer bounding box of the corresponding connected domain, and the height of the extended bounding box is 0.3 times the height of the outer bounding box of the corresponding connected domain. It may be noted that a specific setting of the preset extended ratio may be set according to a specific need. For example, a value of the preset extended ratio may be an empirical value obtained during multiple trials or may also be other values,the value of the preset extended ratio is not limited in the embodiments of the present invention.

b. the process of performing an aggregating processing operation on the outer bounding boxes according to the generated extended bounding boxes may include:

judging whether an IOU value of extended bounding boxes of two connected domains (a ratio of an intersection range to a union of the two connected domains) is within a preset IOU threshold range, and if so, the outer bounding boxes corresponding to the extended bounding boxes of the two connected domains being aggregated; otherwise, the outer bounding boxes corresponding to the extended bounding boxes of the two connected domains being not aggregated.

The IOU threshold may be 0.1.

By aggregating the outer bounding boxes of the connected domains according to an intersection situation of the extended bounding boxes, the method is simple and intuitive, and is convenient to transform, adjust and modify parameters for different scenes.

105: performing a text line recognition operation according to a result of the aggregating processing operation.

The text line may refer to a horizontal text line, a vertical text line, an oblique text line and so on. The text line recognition operation for the horizontal text line is a most used operation.

The horizontal text line may be recognized according to the result of the aggregating processing operation by the following way.

For example, if the number of bounding boxes after the aggregating processing operation is greater than or equal to a preset number, and a variance of y of central position coordinates (x, y) of the bounding boxes in an aggregation class is less than a preset value, the text line may be determined as the horizontal text line. The preset number may be 2, and the preset value of the variance of the coordinate y may be 0.2. If the number of the bounding boxes after the aggregating processing operation is less than the preset number, or the center position coordinatesy are distributed discretely, the text line may not be determined as the horizontal text line.

It may be noted that when recognizing the vertical text line and the oblique text line, a corresponding parameter may be set according to an actual experiment. For example, when recognizing the vertical text line, if the number of the bounding boxes after the aggregating processing operation is greater than the preset number, and a variance of x of the center position coordinates (x, y) of the bounding boxes in the aggregation class is less than the preset value,the text line may be determined as the vertical text line. The preset number and the preset value of the variance of x may be set according to an actual situation. A recognition principle for the oblique text line is similar to that for the horizontal text line or the oblique text line. The recognition principle for the oblique text line may not be described herein.

At the same time, it may be noted that recognizing the text line mainly refers to distinguishing whether a content of the bounding box after the aggregating processing operation belongs to a text line or a non-text image. A recognition method maybe a complex classification method (such as Support Vector Machine, SVM), or a simple two-class decision criterion. A feature of the text line is mainly extracted through a connected domain in the box. Generally, for simplicity, a center position of the box may be used directly. In the complex classification method (such as SVM), text lines need to be collected in advance for training a classifier generally, and then the feature of the text line need to be inputted into the trained classifier to determine whether the text line belongs to a text line class. In the two-class decision criterion, by mainly judging whether positions of the boxes in a candidate text line a redistributed linearly (for example, distributed along a horizontal line), whether the candidate text line is a text line is determined. If the positions of the boxes in the candidate text line are distributed linearly, the candidate text line is regarded as the text line, otherwise it is not. In addition, other recognition methods may also be adopted, and the specific recognition methods are not limited in the embodiments of the present invention.

The horizontal text line is determined according as the number of the bounding boxes after the aggregating processing operation is greater than or equal to the preset number, and the variance of y of the central position coordinates (x, y) of the bounding boxes in the aggregation class is less than the preset value. Compared with a DNN model including multilayer networks, the method is simple to implement and operate, and can improve the detection accuracy on the basis of rapid detection.

In the text line detecting method according to the embodiments of the present invention, by means of performing the binarization preprocessing operation on the input image, performing the filtering operation on the connected domains of the binarization image, the abnormal connected domain and the non-text image area may be removed by the filtering operation. Thereby, interferences of the abnormal connected domain and the non-text image area for detecting the text line may be avoided, and the accuracy and efficiency of detection of the text line are improved. Further, in the text line detecting method according to the embodiments of the present invention,the connected domains conforming to the standard font size are extended according to the preset ratio to generate the extended bounding boxes. Since the center of each of the generated extended bounding boxes being aligned with the center of the corresponding outer bounding box, the aggregating processing operation may be performed on the outer bounding boxes according to the extended bounding boxes. Thereby, the text line may be recognized according to the result of the aggregating processing operation. Coordinates of aggregation centers may be obtained after performing the aggregating processing operation on the outer bounding boxes, and if a preset number of the outer bounding boxes are connected, the text line may be recognized. Therefore, in the text line detecting method according to the embodiments of the present invention, the speed of detecting the text line in the image is improved while detection precision and accuracy may be ensured, and the detection efficiency may be improved.

FIG. 9a is a sample input image for a text line detection according to an embodiment of the present invention. FIG. 9b is a schematic image after preprocessing the sample input image according to the embodiment of the present invention. FIG. 9c is a schematic image of a final text detection result of the sample input image according to the embodiment of the present invention. Specifically, FIG. 9b is the schematic image after performing a binarization processing operation on the input image shown in FIG. 9a.

As shown in FIG. 9a to FIG. 9c, by using the text line detecting method mentioned in the above embodiments of the present invention, a text line in the input image may be detected accurately.

FIG. 10 is a schematic structural diagram of a text line detecting device according to an embodiment of the present invention. As shown in FIG. 10, the text line detecting device according to the embodiment of the present invention includes:

a connected domain generating module 100, configured to perform a preprocessing operation on an image to be detected to generate connected domains;

a filtering module 200, configured to perform a filtering operation on the connected domains to obtain connected domains that meet a preset requirement; and

a recognizing module 300, configured to perform a text line recognizing operation according to a processing result.

In another embodiment of the present invention, the recognizing module 300 is further configured to determine the connected domains in an aggregation class as a text line, when the number of outer bounding boxes in the aggregation class is greater than or equal to a preset number, and a variance of central position coordinates of the outer bounding boxes in the aggregation class is less than a preset value.

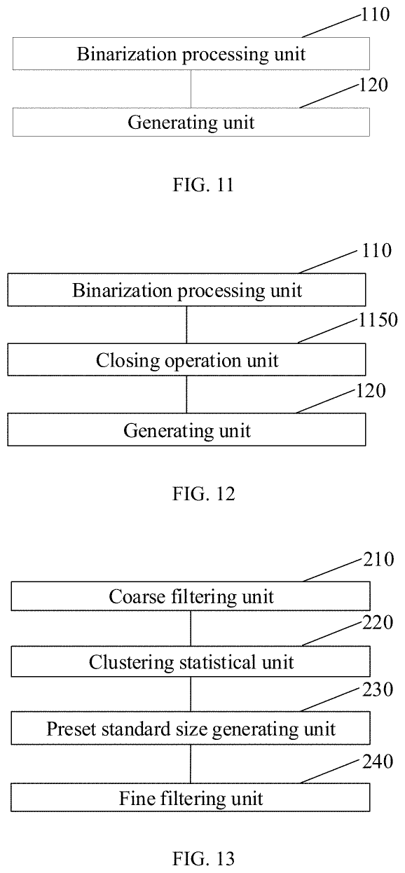

FIG. 11 is a schematic structural diagram of a connected domain generating module of a text line detecting device according to an embodiment of the present invention. As shown in FIG. 11, in the text line detecting device according to the embodiment of the present invention, the connected domain generating module 100 includes:

a binarization processing unit 110, configured to perform a binarization processing operation on the image to be detected; and

a generating unit 120, configured to generate the connected domains according to the processed image to be detected.

FIG. 12 is a schematic structural diagram of a connected domain generating module of a text line detecting device according to another embodiment of the present invention. Specifically, the embodiment shown in FIG. 12 of the present invention is extended on the basis of the embodiment shown in FIG. 11. Differences will be described below, and similarities are not described redundantly herein.

As shown in FIG. 12, in the text line detecting device according to the embodiment of the present invention, the connected domain generating module 100 further includes:

a closing operation unit 1150, configured to perform a closing operation on the image to be detected after the binarization processing operation.

FIG. 13 is a schematic structural diagram of a filtering module of a text line detecting device according to an embodiment of the present invention. As shown in FIG. 13, in the text line detecting device according to the embodiment of the present invention, the filtering module 200 includes:

a coarse filtering unit 210, configured to perform a coarse filtering operation on the connected domains according to a preset abnormal threshold and size data of the obtained connected domains;

a clustering statistical unit 220, configured to perform a clustering statistical operation on the size data of the connected domains after the coarse filtering operation;

a preset standard size generating unit 230, configured to regard size data which the number of occurrence times reaching the number of preset times as preset standard size data; and

a fine filtering unit 240, configured to perform a fine filtering operation on the connected domains according to the preset standard size data and the size data of the obtained connected domains to acquire the connected domains that meet the preset requirement.

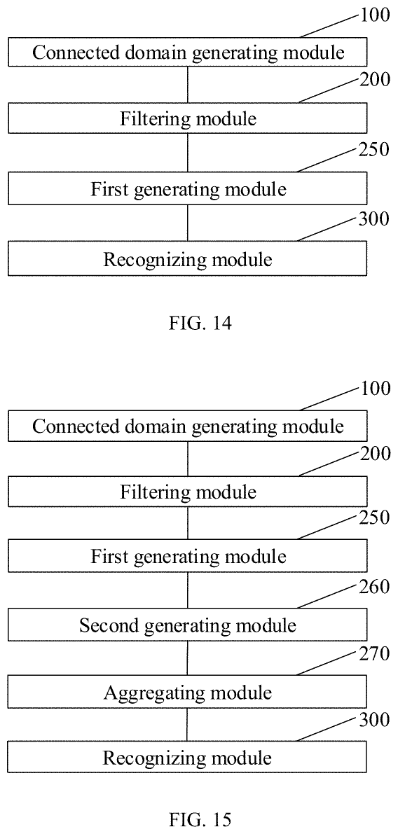

FIG. 14 is a schematic structural diagram of a text line detecting device according to another embodiment of the present invention. Specifically, the embodiment shown in FIG. 14 of the present invention is extended on the basis of the embodiment shown in FIG. 10. Differences will be described below, and similarities are not described redundantly herein.

As shown in FIG. 14, in the text line detecting device according to the embodiment of the present invention, the method further includes:

a first generating module 250, configured to generate outer bounding boxes corresponding to the obtained connected domains that meet the preset requirement.

FIG. 15 is a schematic structural diagram of a text line detecting device according to still another embodiment of the present invention. Specifically, the embodiment shown in FIG. 15 of the present invention is extended on the basis of the embodiment shown in FIG. 14. Differences will be described below, and similarities are not described redundantly herein.

As shown in FIG. 15, in the text line detecting device according to the embodiment of the present invention, the method further includes:

a second generating module 260, configured to generate extended bounding boxes based on the outer bounding boxes according to a preset ratio; and

an aggregating module 270, configured to perform an aggregating processing operation on the outer bounding boxes according to the generated extended bounding boxes.

In another embodiment of the present invention, the second generating module 260 is further configured to extend each of the connected domains conforming to the standard font size to a corresponding extended bounding box which a width is greater than a height according to the preset ratio,and making a center of each of the outer bounding boxes being aligned with a center of the corresponding extended bounding box.

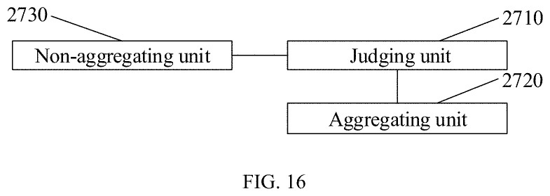

FIG. 16 is a schematic structural diagram of an aggregating module of a text line detecting device according to an embodiment of the present invention. As shown in FIG. 16, in the text line detecting device according to the embodiment of the present invention, the aggregating module 270 includes:

a judging unit 2710, configured to judge whether an IOU value of extended bounding boxes corresponding to at least two connected domains reaches a preset IOU threshold range;

an aggregating unit 2720, configured to perform an aggregating processing operation on the outer bounding boxes corresponding to the extended bounding boxes of the at least two connected domains to generate an aggregation class including at least two outer bounding boxes, when the IOU value of the extended bounding boxes corresponding to the at least two connected domains reaches the preset IOU threshold range; and

a non-aggregating unit 2730, configured to not perform the aggregating processing operation.

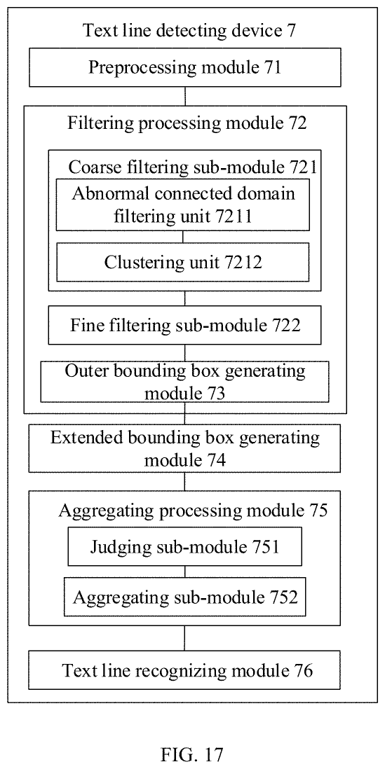

FIG. 17 is a schematic structural diagram of a text line detecting device according to yet still another embodiment of the present invention. Referring to FIG. 17, the text line detecting device 7 includes:

a preprocessing module 71, configured to perform a binarization preprocessing operation on an input image to obtain a preprocessed binarization image;

a filtering processing module 72, configured to perform a filtering operation on the connected domains of the binarization image, and then obtain a standard font size and connected domains conforming to the standard font size after the filtering operation;

an outer bounding box generating module 73, configured to generate the outer bounding boxes for the connected domains conforming to the standard font size;

an extended bounding box generating module 74, configured to extend the connected domains conforming to the standard font size according to a preset ratio to generate extended bounding boxes;

an aggregating processing module 75, configured to perform an aggregating processing operation on the outer bounding boxes according to the extended bounding boxes; and

a text line recognizing module 76, configured to perform a text line recognition operation according to a result of the aggregating processing operation.

Further, the filtering processing module 72 includes a coarse filtering sub-module 721 and a fine filtering sub-module 722. The coarse filtering sub-module 721 specifically includes:

an abnormal connected domain filtering unit 7211, configured to obtain the connected domains of the binarization image, and filter one or more abnormal connected domains of the connected domains according to a preset abnormal threshold, and the abnormal threshold may refer to an abnormal threshold set according to a pixel or an abnormal threshold set according to a width-to-height ratio of a connected domain; and

a clustering unit 7212, configured to obtain width values and height values of the remaining connected domains after the coarse filtering operation, and cluster the width values and the height values of the remaining connected domains after the coarse filtering operation by using a statistical clustering algorithm to count a width value and a height value of a connected domain with the most number of occurrence times as a standard font size.

Further, the fine filtering sub-module 722 is specifically configured to:

according to the standard font size, filter the remaining connected domains after the coarse filtering operation in the binarization image according to a preset multiple of the width value and the height value of the standard font size; and

obtain the connected domains after the fine filtering operation in the binarization image.

Further, the extended bounding box generating module 74 is specifically configured to convert each of the connected domains conforming to the standard font size to a corresponding extended bounding box whose width is greater than height according to the preset ratio,and making a center of the extended bounding box being aligned with a center of the corresponding outer bounding box.

The aggregating processing module 75 includes a judging sub-module 751 and an aggregating sub-module 752.

The judging sub-module 751 is configured to judge whether an IOU value of the extended bounding boxes of two connected domains (a ratio of an intersection range to a union of the two connected domains) is within a preset IOU threshold range, and if so, the aggregating sub-module 752 is configured to aggregate the outer bounding boxes corresponding to the extended bounding boxes of the two connected domains; otherwise, the aggregating sub-module 752 is configured to not aggregate the outer bounding boxes corresponding to the extended bounding boxes of the two connected domains.

Further, the text line recognizing module 76 is specifically configured to:

determine the text line as a horizontal text line, if the number of bounding boxes after the aggregating processing operation is greater than or equal to a preset number, and a variance of y of central position coordinates (x, y) of the bounding boxes in an aggregation class is less than a preset value;and determine the text line not as the horizontal text line, if the number of the bounding boxes after the aggregating processing operation is less than the preset number, or the center position coordinatesy are distributed discretely.

In the text line detecting device according to the embodiments of the present invention,by means of performing the binarization preprocessing operation on the input image, performing the filtering operation on the connected domains of the binarization image, the abnormal connected domain and the non-text image area may be removed by the filtering operation. Thereby, interferences of the abnormal connected domain and the non-text image area for detecting the text line may be avoided, and the accuracy and efficiency of detection of the text line are improved. Further, in the text line detecting device according to the embodiments of the present invention,the connected domains conforming to the standard font size are extended according to the preset ratio to generate the extended bounding boxes. Since the center of each of the generated extended bounding boxes being aligned with the center of the corresponding outer bounding box, the aggregating processing operation may be performed on the outer bounding boxes according to the extended bounding boxes. Thereby, the text line may be recognized according to the result of the aggregating processing operation. Coordinates of aggregation centers may be obtained after performing the aggregating processing operation on the outer bounding box, and if a preset number of the outer bounding boxes are connected, the text line may be recognized. Therefore, in the text line detecting device according to the embodiments of the present invention, the speed of detecting the text line in the image is improved while detection precision and accuracy may be ensured, and the detection efficiency may be improved.

All of the above optional technical solutions may be used in any combination to form an optional embodiment of the present invention, and the optional embodiment of the present invention will not be described redundantly herein.

It may be noted that when the text line detecting methods are performed by the text line detecting device according to the above embodiments, divisions in the above functional modules are illustrated by examples. In an actual application, the above functions may be allocated to different functional modules according to a need. That is, the internal structure of the device is divided into different functional modules to complete all or part of the functions described above. In addition, the text line detecting devices mentioned in the above embodiments and the text line detecting methods mentioned in the above embodiments belong to a same concept. Specific implementation processes of the text line detecting devices may refer to the method embodiments, and details are not described herein again.

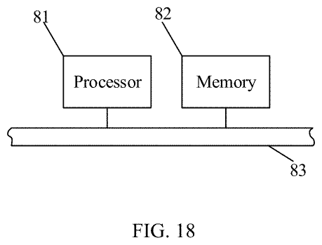

FIG. 18 is a schematic structural diagram of an electronic equipment according to an embodiment of the present invention. The electronic equipment provided in FIG. 18 is configured to perform the text line detecting methods mentioned in the above embodiments. As shown in FIG. 18, the electronic equipment includes a processor 81, a memory 82 and a bus 83.

The processor 81 is configured to call a code stored in the memory 82 by using the bus 83 to perform a preprocessing operation on an image to be detected to generate connected domains; perform a filtering operation on the connected domains to obtain connected domains that meet a preset requirement; and perform a text line recognizing operation according to a processing result.

It may be understood that the electronic equipment includes, but is not limited to, an electronic equipment such as a mobile phone, a tablet computer and so on.

In an embodiment of the present invention, a computer readable storage medium is further provided. A text line detecting program is stored in the computer readable storage medium. When the text line detecting program is executed by a processor, the text line detecting method mentioned in any one of the above embodiments is realized.

It may be understood that the computer readable storage medium refers to a memory such as a CD-ROM, a floppy disk, a hard disk, a Digital Versatile Disc (DVD), a blue-ray discand other forms of memories. Alternatively, some or all operations of the text line detecting method mentioned in the above embodiments may be implemented according to any combination of an Application Specific Integrated Circuit (ASIC), a Programmable Logic Device (PLD), an Erasable programmable Logic Device (EPLD), a discrete logic, a hardware,a firmware and so on. In addition, although the flowcharts of the above embodiments describe the text line detecting method, an operation in the text line detecting method may be modified, deleted, or merged.

As described above, the text line detecting method mentioned in any one of the above embodiments may be implemented according to a coded instruction (such as a computer readable instruction). The coded instruction is stored on a tangible computer readable medium, such as a hard disk, a flash memory, a Read Only Memory (ROM), a Compact Disc (CD), a DVD, a cache, a Random Access Memory (RAM), and/or any other storage mediums in the tangible computer readable storage medium, information may be stored for any time (such as long time, permanence, transience, temporary buffering, and/or caching of information).As used herein, the term tangible computer readable medium is defined expressly to include any type of computer readable stored signals. Additionally or alternatively, the examplary processes of the text line detecting methods mentioned in the above described embodiments may be implemented according to the coded instruction (such as the computer readable instructions). The coded instruction is stored on a non-transitory computer readable storage medium such as a hard disk, a flash memory, a ROM, a CD, a DVD, a cache, a RAM and/or any other storage mediums. In the non-transitory computer readable storage medium, information may be stored for any time (such as long time, permanence, transience, temporary buffering, and/or caching of information).

Those skilled in the art may understand that all or part of the steps of the above embodiments may be realized by a hardware, or may be realized by a program to instruct a related hardware. The program may be stored in a computer readable storage medium. The storage medium mentioned above may be a ROM, a magnetic disk, a CD and so on.

The above embodiments are only the preferred embodiments of the present invention and are not configured to limit the scope of the present invention. Any modification, equivalent substitution and improvement made within the spirit and principle of the present invention may be included within the scope of the present invention.

What is claimed is:

1. A text line detecting method,comprising:
performing a preprocessing operation on an image to be detected to generate connected domains;
performing a filtering operation on the connected domains to obtain connected domains that meet a preset requirement; and
performing a text line recognizing operation according to a processing result.

2. The text line detecting method according to claim 1, wherein the performing a preprocessing operation on an image to be detected to generate connected domains comprises:
performing a binarization processing operation on the image to be detected; and
generating the connected domains according to the processed image to be detected.

3. The text line detecting method according to claim 2, wherein after the performing a binarization processing operation on the image to be detected, the method further comprises:
performing a closing operation on the image to be detected after the binarization processing operation.

4. The text line detecting method according to claim 1, wherein the performing a filtering operation on the connected domains to obtain connected domains that meet a preset requirement comprises:
performing a fine filtering operation on the connected domains according to preset standard size data and size data of the obtained connected domains to acquire the connected domains that meet the preset requirement.

5. The text line detecting method according to claim 4, wherein before the performing a fine filtering operation on the connected domains according to preset standard size data and size data of the obtained connected domains to acquire the connected domains that meet the preset requirement, the method further comprises:
performing a coarse filtering operation on the connected domains according to a preset abnormal threshold and the size data of the obtained connected domains;
performing a clustering statistical operation on the size data of the connected domains after the coarse filtering operation; and
regarding size data which the number of occurrence times reaching the number of preset times as the preset standard size data.

6. The text line detecting method according to claim 5, wherein the preset abnormal threshold comprises either or both of a preset abnormal threshold set according to a pixel and a preset abnormal threshold set according to the size data of the connected domains.

7. The text line detecting method according to claim 1, wherein after the performing a filtering operation on the connected domains to obtain connected domains that meet a preset requirement, the method further comprises:
generating outer bounding boxes corresponding to the obtained connected domains that meet the preset requirement.

8. The text line detecting method according to claim 7, wherein after the generating outer bounding boxes corresponding to the obtained connected domains that meet the preset requirement, the method further comprises:
generating extended bounding boxes based on the outer bounding boxes according to a preset ratio; and
performing an aggregating processing operation on the outer bounding boxes according to the generated extended bounding boxes.

9. The text line detecting method according to claim 8, wherein the generating extended bounding boxes based on the outer bounding boxes according to a preset ratio comprises:
extending each of the outer bounding boxes of the connected domains into an extended bounding box which a width is greater than a height according to the preset ratio, wherein a center of each of the outer bounding boxes is aligned with a center of the corresponding extended bounding box.

10. The text line detecting method according to claim 8, wherein the performing an aggregating processing operation on the outer bounding boxes according to the generated extended bounding boxes comprises:
judging whether an IOU value of extended bounding boxes corresponding to at least two connected domains reaches a preset IOU threshold range; and
when the IOU value of the extended bounding boxes corresponding to the at least two connected domains reaches the preset IOU threshold range, performing the aggregating processing operation on the outer bounding boxes corresponding to the extended bounding boxes of the at least two connected domains to generate an aggregation class comprising at least two outer bounding boxes.

11. The text line detecting method according to claim 10, wherein the performing a text line recognizing operation according to a processing result comprises:
when the number of the outer bounding boxes in the aggregation class is greater than or equal to a preset number, and a variance of central position coordinates of the outer bounding boxes in the aggregation class is less than a preset value, determining the connected domains in the aggregation class as a text line.

12. A text line detecting device, comprising a memory, a processor, and a computer program stored in the memory and executed by the processor, wherein when the computer program is executed by the processor, the processor implements the following steps:
performing a preprocessing operation on an image to be detected to generate connected domains;
performing a filter operation on the connected domains to obtain connected domains that meet a preset requirement; and
performing a text line recognizing operation according to a processing result.

13. The text line detecting device according to claim 12, wherein when implementing the step of performing a preprocessing operation on an image to be detected to generate connected domains, the processor specifically implements the following steps:
performing a binarization processing operation on the image to be detected; and
generating the connected domains according to the processed image to be detected.

14. The text line detecting device according to claim 13,wherein when implementing the step of performing a preprocessing operation on an image to be detected to generate connected domains, the processor specifically further implements the following step:
performing a closing operation on the image to be detected after the binarization processing operation.

15. The text line detecting device according to claim 12, wherein when implementing the step of performing a filter operation on the connected domains to obtain connected domains that meet a preset requirement, the processor specifically implements the following step:
performing a fine filtering operation on the connected domains according to preset standard size data and size data of the obtained connected domains to acquire the connected domains that meet the preset requirement.

16. The text line detecting device according to claim 15, wherein when implementing the step of performing a filter operation on the connected domains to obtain connected domains that meet a preset requirement, the processor specifically further implements the following steps:
performing a coarse filtering operation on the connected domains according to a preset abnormal threshold and the size data of the obtained connected domains;
performing a clustering statistical operation on the size data of the connected domains after the coarse filtering operation; and
regarding size data which the number of occurrence times reaching the number of preset times as the preset standard size data.

17. The text line detecting device according to claim 12, wherein when the computer program is executed by the processor,the processor further implements the following step:
generating outer bounding boxes corresponding to the obtained connected domains that meet the preset requirement.

18. The text line detecting device according to claim 17, wherein when the computer program is executed by the processor,the processor further implements the following steps:
generating extended bounding boxes based on the outer bounding boxes according to a preset ratio; and
performing an aggregating operation on the outer bounding boxes according to the generated extended bounding boxes.

19. The text line detecting device according to claim 18, wherein when implementing the step of performing an aggregating operation on the outer bounding boxes according to the generated extended bounding boxes, the processor specifically implements the following steps:
judging whether an IOU value of extended bounding boxes corresponding to at least two connected domains reaches a preset IOU threshold range; and
performing the aggregating processing operation on the outer bounding boxes corresponding to the extended bounding boxes of the at least two connected domains,when the IOU value of the extended bounding boxes corresponding to the at least two connected domains reaches the preset IOU threshold range, to generate an aggregation class comprising at least two outer bounding boxes.

20. A computer readable storage medium storing a data sharing program for causing a processor to execute the text line detecting method according to claim 1.
